(19) United States
(12) Patent Application Publication
(10) Pub. No.: US 2005/0106394 A1
(43) Pub. Date: May 19, 2005

(54) Transparent chemically resistant polymer composite

(76) Inventor: James D. Osterloh, West Richland, WA (US)

Correspondence Address: SHELDON & MAK, 9th Floor, 225 South Lake Avenue, Pasadena, CA, 91101, US

(21) Appl. No.: 10/714,292

(22) Filed: Nov. 13, 2003

(51) Int. Cl. B32B 27/08

(52) U.S. Cl. 428/421; 428/412

(57) ABSTRACT

A transparent composite has a first layer of a transparent substrate polymer material and a second layer of a transparent fluorocarbon polymer film. The second layer is bonded to the first layer either by an adhesive, by a heat process or by a chemical vapor deposition process.

### BACKGROUND OF THE INVENTION

Chemical laboratory reaction enclosures, such as glove boxes, are commonly used in chemical laboratories to provide boundaries for chemical reactions wherein the reactants, the products, or both are toxic, caustic or otherwise harmful. The term “caustic” as used herein is meant in the broad sense to denote materials which are either quite acidic or quite basic.

Chemical Laboratory reaction enclosures are typically equipped with one or more transparent panels to facilitate preparation of the reactants and to monitor the progress of the chemical reaction.

Depending on the requirements of the specific application, the material used in the fabrication of the transparent viewing panel may vary. For instance, if an application requires that the transparent viewing panel possesses superior impact resistance then polycarbonate may be the material of choice. Alternatively, if the requirement is for superior fire resistance, polyvinyl chloride (PVC) sheet may be used. Acrylic sheet, although somewhat brittle, may be the material of choice in some applications due to its optical characteristics or resistance to abrasion.

Though there are many choices of material, a pervasive problem for the industry has been that prolonged exposure to caustic liquids and vapors cause all of these materials become “hazy”, losing the transparency the material was chosen for. In most applications, glass is excluded from consideration because of its brittle nature, even though its chemical resistance is very good.

There is a substantial need for a transparent polymer material that will not lose its transparency over time, regardless of the harsh chemical exposure it is subjected to.

### SUMMARY OF THE INVENTION

The invention described herein satisfies the need for a polymer material that will not lose its transparency when subjected to prolonged exposure to a harsh chemical environment. The invention is a composite of an appropriately chosen substrate (such as polycarbonate, PVC, acrylic, etc.) polymer material chemically bonded, either by heat, chemical vapor deposition or adhesive, to a transparent fluorocarbon polymer film. Depending on specific requirements, this may vary from a single sheet of substrate bonded to a single sheet of fluorocarbon polymer film, to several sheets of similar or dissimilar substrate polymer bonded on both sides to sheets of fluorocarbon polymer. The bonding between the fluorocarbon film and the substrate material may be accomplished in several different ways, including: (1) use of commercially available adhesives compatible with both the fluorocarbon film and the substrate polymer; (2) application of heat; (3) use of the fluorocarbon film itself as an adhesive; and (4) use of an appropriate chemical vapor deposition procedure. The central idea here, and the core of the innovation, is the bonding of transparent fluorocarbon polymer film to a transparent substrate polymer with the intention of producing a transparent viewing panel that is highly resistant to degradation due to prolonged exposure to harsh chemical environments.

The term “bonding” as used herein is meant to denote “chemical bonding” wherein one material is adhered to another throughout their contiguous surfaces by chemical bonds.

It should be noted here, that the concept of the invention differs substantially from the separate and distinct concept of applying transparent fluorocarbon polymer film to a polymer substrate by means other than bonding. This approach is used in the production of face shields for Haz-Mat® suits made by Kappler USA, of Guntersville, Ala. In the production of these suits, a film of fluorocarbon polymer is applied over a transparent face shield by means of a special taping process around the outside edges of the fluorocarbon film. While this process may be suitable for small face shield applications, it is not suitable for the larger type of viewing panels described herein. Compared to the process in which fluorocarbon film is taped to a substrate material, there are substantial benefits and advantages of preparing composites of fluorocarbon bonded to suitable substrate polymer sheets. Prominent among these advantages is the gain in manufacturing efficiency of having the pre-bonded fluorocarbon and substrate material available to the manufacturing process as a raw material. This separates the process of applying the fluorocarbon to the substrate from the process employed to manufacture the end product. Rather than having to deal with the process of applying the fluorocarbon to the substrate during manufacture of the end product, the manufacturer can stockpile the pre-bonded material for use as needed. Another chief advantage of the product described herein is the superior optical quality achievable by means of bonding the fluorocarbon polymer to the substrate polymer. Bonding, whether by heat, use of a transparent adhesive or chemical vapor deposition, improves optical clarity by eliminating the inevitable air gap between non-bonded fluorocarbon film and the substrate polymer.

### DRAWINGS

These features, aspects and advantages of the present invention will become better understood with regard to the following description, appended claims and accompanying figures where:

FIG. 1 is a cross section of a transparent composite having features of the invention; and

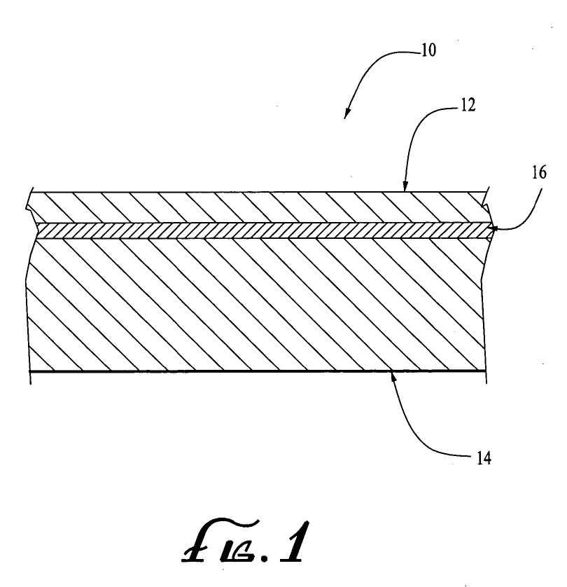

FIG. 2 is a perspective view of a chemical laboratory reaction enclosure having features of the invention.

### DETAILED DESCRIPTION

The following discussion describes in detail several embodiments of the invention and several variations of those embodiments. This discussion should not be construed, however as limiting the invention to those particular embodiments. Practitioners skilled in the art will recognize numerous other embodiments as well.

The invention is a transparent composite 10 comprised of a first layer 12 and a second layer 14.

The first layer 12 is the polymer substrate material. Many transparent polymer materials may be chosen for this layer, including but not limited to, polycarbonate, polyvinyl chloride (PVC), acrylic, etc. One useful substrate polymer material used in the first layer 12 is an uncoated grade of polycarbonate such as Lexan® 9034 (manufactured by GE Plastics of Pittsfield, Mass.). Alternatively the polycarbonate can be coated on one or both of its two flat sides. For example, Lexan® MR-AC has a flame-retardant coating on one side and an abrasion/ultraviolet resistant coating on its opposite side. Lexan® MR-AC can also be purchased from GE Plastics. Lexan® MR 10 is another commercially available polycarbonate manufactured by GE Plastics. Lexan® MR 10 is coated on both sides with an abrasion/ultraviolet resistant coating. Most applications would require that the first layer 12 be 0.25-inch to 0.50-inch thick.

Another useful substrate polymer material used in the first layer 12 is a thin flexible polymer sheet, such as PVC.

The second layer 14 is a transparent fluorocarbon polymer film. This layer is typically 1 to 5 mils thick (0.001 to 0.005 inch). Where the layer is deposited by chemical vapor deposition techniques, the layer can be much thinner, for example, on the order of 40 microns. This film must be sufficiently transparent to allow its use in the manufacture of a viewing panel. The second layer 14 must be bondable to the first layer 12 by means of a suitable adhesive layer 16, or by heat or chemical vapor deposition, in which case no adhesive is used.

One transparent fluorocarbon polymer usable as a second layer 14 in the transparent composite 10 is DuPont Tefzel® ETFE (DuPont High Performance Films of Centerville, Ohio). Tefzel® is ethylene tetrafluoroethylene, having the chemical formula [—CF₂—CF₂—CH₂]ₙ. Typically, n is of a value such that the transparent fluorocarbon polymer has a density between about 1.7 g/cm³ (at 23° C.) and about 1.8 g/cm³ (at 23° C.) and has a tensile strength of between 5,000 psi at 25° C. and about 7,000 psi at 25° C.

Tefzel® ETFE and several other polymers suitable for the second layer 14 are shown in the following table:

| Chemical Formula | Common Name | Marketed by |
|---|---|---|
| [—CF₂—CF₂—CH₂—CH₂]ₙ | Tefzel ® ETFE | DuPont High Performance Films of |
| | | Centerville, Ohio |
| [—CF₂—CF₂—CF₂—CF(CF₃)—]ₙ | Teflon ® FEP | DuPont High Performance Films |
| [—CF₂—CF₂—CF(OC₃F₇)—CF₂—]ₙ | Teflon ® PFA | DuPont High Performance Films |
| [—CFCl—CF₂—]ₙ | ACLAR ® CTFE | Honeywell, Inc. of Morristown, New |
| | | Jersey |
| [—CF₂—CFCl—CF₂—CFCl]—]ₙ | HALAR ® ECTFE | Honeywell, Inc. |

The transparent adhesive layer 16, when used, can be any suitable adhesive capable of cementing the first layer 12 to the second layer 14 while remaining transparent. One such adhesive that is suitable for bonding Tefzel® ETFE to polycarbonate is an adhesive marketed by DuPont as Adhesive 68040.

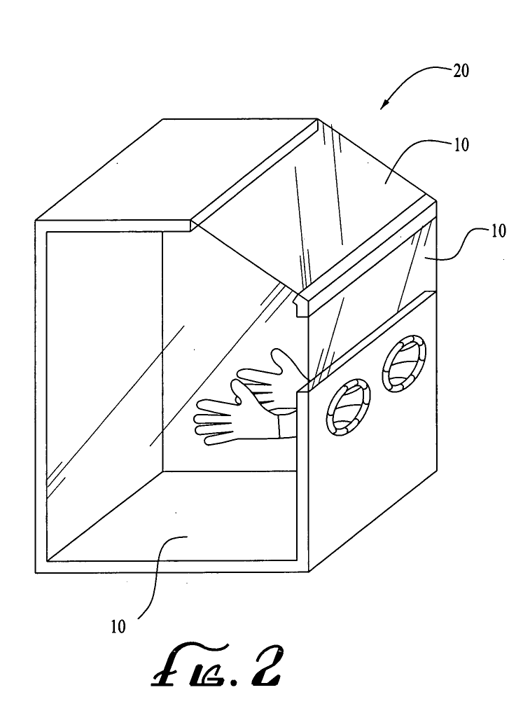

The composite 10 of the invention is ideal as a transparent viewing panel in a chemical laboratory reaction enclosure 20, such as in a glove box as illustrated in FIG. 2, or as transparent walls between designated areas in a room of a building, such as in a laboratory.

Where the first layer 12 is a thin flexible polymer sheet, the resulting transparent composite 10 is in itself flexible. Such a flexible transparent composite 10 can be used to make face shields for chemical suits as well as for glove boxes and other uses.

### EXAMPLE

A sheet of Lexan® 9034 was exposed to a 20% sodium hydroxide solution for 24 hours. After the 24-hour exposure, the specimen was rinsed with water and wiped with a piece of rubber. The specimen was observed to have developed a very slight haze and numerous surface cracks.

A composite 10 was prepared with a sheet of Lexan® 9034 as a first layer 12 and a 2.5 mil thick sheet of Tefzel® ETFE cemented to one surface of the first layer 12 using DuPont adhesive 68040. The Tefzel® ETFE of the composite 10 was exposed to a 20% sodium hydroxide solution for a period of 24 hours. At the end of the 24 hour period, the Tefzel® ETFE side of the composite 10 was rinsed with water and wiped with a piece of rubber. The composite 10 was observed to have no reduction in transparency. No haze was observed and no cracks were observed.

Having thus described the invention, it should be apparent that numerous structural modifications and adaptations may be resorted to without departing from the scope and fair meaning of the instant invention as set forth herein above and as described herein below by the claims.

1. A transparent composite comprising:
(a) a first layer comprising a transparent substrate polymer material; and
(b) a second layer comprising a transparent fluorocarbon polymer film; wherein the second layer is bonded to the first layer.

2. The transparent composite of claim 1 further comprising a transparent adhesive layer disposed between the first layer and the second layer.

3. The transparent composite of claim 1 wherein the first layer is a polycarbonate.

4. The transparent composite of claim 1 wherein the second layer consists essentially of a transparent fluorocarbon polymer.

5. The transparent composite of claim 1 wherein the second layer comprises a transparent material having the formula [—CF₂—CF₂—CH₂—CH₂]ₙ.

6. The transparent composite of claim 1 wherein the second layer consists essentially of a transparent material having the formula [—CF₂—CF₂—CH₂—CH₂—CH₂]ₙ.

7. The transparent composite of claim 1 wherein the second layer comprises a transparent material having the formula [—CF₂—CF₂—CH₂—CH₂]ₙ, where n is of a value such that the transparent fluorocarbon polymer has a density between 1.7 and 1.8 and has a tensile strength of between about 5,000 psi at 25° C. and 7,000 psi at 25° C.

8. The transparent composite of claim 1 wherein the second layer consists essentially of a transparent material having the formula [—CF₂—CF₂—CH₂—CH₂]ₙ, where n is of a value such that transparent fluorocarbon polymer has a density between 1.7 and 1.8 and has a tensile strength of between about 5,000 psi at 25° C. and 7,000 psi at 25° C.

9. The transparent composite of claim 1 wherein the second layer comprises a transparent material having the formula [—CF₂—CF₂—CF₂—CF(CF₃)—]ₙ.

10. The transparent composite of claim 1 wherein the second layer consists essentially of a transparent material having the formula [—CF₂—CF₂—CF₂—CF(CF₃)—ₙ.

11. The transparent composite of claim 1 wherein the second layer comprises a transparent material having the formula [—CF₂—CF₂—CF(OC₃F₇)—CF₂—]ₙ.

12. The transparent composite of claim 1 wherein the second layer consists essentially of a transparent material having the formula [—CF₂—CF₂—CF(OC₃F₇)—CF₂—]ₙ.

13. The transparent composite of claim 1 wherein the second layer comprises a transparent material having the formula [—CFCl—CF₂—]ₙ.

14. The transparent composite of claim 1 wherein the second layer consists essentially of a transparent material having the formula [—CFCl—CF₂—]ₙ.

15. The transparent composite of claim 1 wherein the second layer comprises a transparent material having the formula [—CF₂—CFCl—CF₂—CFCl—]ₙ.

16. The transparent composite of claim 1 wherein the second layer consists essentially of a transparent material having the formula [—CF₂—CFCl—CF₂—CFCl—]ₙ.

17. The transparent composite of claim 1 wherein the first layer is flexible.

18. A chemical laboratory reaction enclosure having a transparent window, the transparent window being a transparent composite comprising:
(a) a first layer comprising a substrate polymer material; and
(b) a second layer comprising a transparent fluorocarbon polymer; wherein the second layer is bonded to the first layer.

19. The chemical reaction laboratory reaction enclosure of claim 18 wherein the second layer consists essentially of a transparent fluorocarbon polymer.

20. The chemical reaction laboratory reaction enclosure of claim 18 wherein the second layer comprises a transparent material having the formula [—CF₂—CF₂—CH₂—CH₂—]ₙ.

21. The chemical reaction laboratory reaction enclosure of claim 18 wherein the second layer consists essentially of a transparent material having the formula [—CF₂—CF₂—CH₂—CH₂]ₙ.

22. The chemical reaction laboratory reaction enclosure of claim 18 wherein the second layer comprises a transparent material having the formula [—CF₂—CF₂—CH₂—CH₂ —]ₙ, where n is of a value such that the transparent fluorocarbon polymer has a density between 1.7 and 1.8 and has a tensile strength of between about 5,000 psi at 25° C. and 7,000 psi at 25° C.

23. The chemical reaction laboratory reaction enclosure of claim 18 wherein the second layer consists essentially of a transparent material having the formula [—CF₂—CF₂—CH₂—CH₂—]ₙ, where n is of a value such that the transparent fluorocarbon polymer has a density between 1.7 and 1.8 and has a tensile strength of between about 5,000 psi at 25° C. and 7,000 psi at 25° C.
